(19) United States
(12) Patent Application Publication
(10) Pub. No.: US 2014/0284314 A1
(43) Pub. Date: Sep. 25, 2014

(54) TEMPERATURE REGULATION OF HEATED AIR DISTRIBUTION SYSTEMS IN PASSENGER ROOMS

(71) Applicant: Airbus Operations GmbH, Hamburg (DE)

(72) Inventor: Henning EVERTH, Hamburg (DE)

(21) Appl. No.: 14/293,311

(22) Filed: Jun. 2, 2014

Related U.S. Application Data
(63) Continuation of application No. PCT/EP2012/074824, filed on Dec. 7, 2012.
(60) Provisional application No. 61/570,388, filed on Dec. 14, 2011.

(30) Foreign Application Priority Data
Dec. 14, 2011 (DE) 10 2011 121 053.2

(51) Int. Cl. B60H 1/22

(52) U.S. Cl. CPC B60H 1/2218; B60H 1/2225
USPC 219/202

(57) ABSTRACT

A passenger compartment with an air distribution system for a means of transport and a method for regulating an air outlet temperature of an air distribution system in a passenger compartment of a means of transport are provided. In this arrangement the passenger compartment comprises a multitude of temperature zones in each case with several temperature regions with different heat loads. The air distribution system is designed to calculate the heating energy for a heating element in such a manner that the temperature in the entire temperature zone is as uniform as possible.

### CROSS-REFERENCE TO RELATED APPLICATIONS

This is a continuation of International Application No. PCT/EP2012/074824, filed Dec. 7, 2012, which application claims priority to German Patent Application No. 10 2011 121 053.2, filed Dec. 14, 2011 and to U.S. Provisional Patent Application No. 61/570,388, filed Dec. 14, 2011, which are each incorporated herein by reference in their entirety.

### TECHNICAL FIELD

The technical field relates to a passenger compartment with an air distribution system. In particular, the technical field relates to a passenger compartment with an air distribution system for a means of transport, to a means of transport with a passenger compartment, to a method for regulating an air outlet temperature of an air distribution system in a passenger compartment of a means of transport, to a computer program element for controlling an air distribution system, and to a computer-readable medium.

### BACKGROUND

Passenger compartments with air distribution systems and air distribution systems in passenger cabins of means of transport are, for example, used to supply passengers with fresh air, and to set a desired cabin temperature in that from a multitude of air outlets in the passenger cabin correspondingly temperature-controlled or air conditioned air flows. To this effect the air outlets are distributed in the passenger cabin in such a manner that to the greatest extent possible they may achieve room-covering air distribution and a uniform temperature in the passenger cabin.

From EP 1 550 569 A1 and US 2005/0230488 A1 a passenger compartment with an air distribution system is known that comprises a multitude of air outlets that are divided into several temperature zones. Each air outlet comprises a heating element that heats the air flowing from the air outlet so that within a temperature zone a prevailing temperature can be specified.

Within a temperature zone the temperature can be regulated independently of an adjoining temperature zone, in that, for example, several temperature sensors, which are arranged in the temperature zone, acquire the cabin temperature, and a regulating device influences the air temperature at the air outlets by adjusting the heating energy of the heating elements.

In addition, other objects, desirable features and characteristics will become apparent from the subsequent summary and detailed description, and the appended claims, taken in conjunction with the accompanying drawings and this background.

### SUMMARY

Accordingly, there may be a need to provide a passenger compartment with an air distribution system that allows the implementation of alternative temperature regulation in a temperature zone with little construction expenditure.

Many of the characteristics described below with respect to the passenger compartment may also be implemented as method-related steps and vice-versa.

According to one of various aspects of the present disclosure, a passenger compartment with an air distribution system for a means of transport is provided, which air distribution system comprises a control unit, a multitude of air outlets, and at least one heating element. The passenger compartment comprises at least one temperature zone with a first temperature region and a second temperature region, wherein the first temperature region is designed to receive a first heat load, and the second temperature region is designed to receive a second heat load, which first heat load differs from the second heat load, wherein the at least one temperature zone comprises the multitude of air outlets, which multitude of air outlets share a common air supply. In this arrangement the at least one heating element is associated with one of the air outlets in order to heat the air flowing from the one air outlet, which one air outlet is arranged in that temperature region of the first temperature region and of the second temperature region, which temperature region comprises a lower heat load. The control unit is designed to determine a temperature in the at least one temperature zone, and to calculate or determine the heating energy for the at least one heating element. A first group of the air outlets in the first temperature region is designed to output air of a first air outlet temperature to the passenger compartment, and a second group of the air outlets in the second temperature region is designed to outlet air of a second air outlet temperature to the passenger compartment. In this arrangement the control unit is designed to calculate the heating energy for the at least one heating element in such a manner that in the first temperature zone a temperature that is as uniform as possible is achieved.

In this arrangement, in each case one or several heating elements can be associated with, or allocated to, one air outlet, or one or several heating elements can be associated with, or allocated to, a multitude of air outlets.

In this document the term “temperature zone” refers to a region of the passenger compartment in which region all the air outlets share a common air supply and common temperature regulation. In this arrangement a passenger compartment can, in particular, comprise a multitude of temperature zones.

Furthermore, a temperature zone is characterized in that regulation of the temperature in a temperature zone is carried out by a single control loop. This means that the control loop is supplied by a temperature sensor with a measured value that reflects the temperature in the corresponding temperature zone, and, corresponding to the setting of the control loop, the heating energy for the heating elements or the air outlet temperature is adjusted in order to in the case of a temperature value that differs from the setpoint value of the temperature cause a change in the air outlet temperature so that the temperature in the temperature zone changes to a desired direction i.e., depending on the heat load in the temperature region, is increased or decreased. It should be pointed out that the desired air outlet temperature can be brought about both by means of the heating elements and directly by adjusting the temperature of the air in the shared air supply of a temperature zone.

The air distribution system as described above and below may make it possible, in particular, that within a temperature zone a temperature is as uniform as possible, although, for example, a heat load within the temperature zone differs.

The term “heat load” refers to all the influences on the temperature in a temperature zone or in various temperature regions of a temperature zone.

For example, passenger density can have an effect on the heat load to the extent that in the case of a comparatively high passenger density a comparatively high heat load is experienced because the body warmth given off by the passengers can result in an increase in the temperature in the affected region. Conversely, a comparatively low passenger density my result in a comparatively low heat load.

Apart from the passenger density, for example placement of an entrance or an exit to or from the passenger compartment, e.g. an emergency exit door of an aircraft cabin, may also affect the heat load.

The seal of the emergency exit or the door of the emergency exit may represent a cold bridge, for example because of differences in the material used when compared to the material and the nature of the aircraft cabin, and thus can result in a drop in temperature in the immediate vicinity of the emergency exit, which in turn reduces the heat load in the region affected by this. Likewise, the heat load in a region of the passenger cabin may be influenced by the cabin insulation.

A different heat load in an individual temperature zone may thus result in the temperature within the temperature zone not being uniform, and thus in different temperature regions within the temperature zone arising. In particular, the temperature within a temperature zone may fluctuate when the air outlet temperature is uniform in the entire temperature zone, but the heat load in this temperature zone is not uniform.

A temperature region is characterized in that, as a result of the prevailing heat load, the temperature within the temperature region differs from the temperature in an adjacent temperature region within the same temperature zone. If in the case of different heat loads in two temperature regions within a temperature zone the air outlet temperature at the air outlets is identical, this results in either the temperature in the temperature region with a high heat load being too high, or the temperature in the temperature region with a low heat load being too low.

A temperature region is a spatially defined or delimited region within a temperature zone, wherein this region requires a defined temperature of the air flowing from the air outlets in order to achieve a desired ambient temperature in this temperature region or sphere.

Either an increased temperature or a reduced temperature in a passenger cabin can reduce the travelling comfort of passengers. In one example, an increased temperature may, for example, in air travel result in discomfort for passengers, whereas a reduced temperature results in passengers being cold or feeling unwell.

In order to prevent temperature differentials within a temperature zone, i.e. different temperatures in different temperature regions within one and the same temperature zone due to a varying heat load, a heating element in an air outlet is supplied with heating energy in such a manner that the air outlet temperature in the air outlet is increased or decreased according to the heat load, wherein in the case of a high heat load the air outlet temperature is to be lower than in the case of a low heat load.

The air distribution system as described above and below is thus in particular suited to distributing air in a passenger compartment of an aircraft if, for example, various seating configurations or seating layouts exist within a temperature zone.

The seating configuration in a passenger compartment specifies the way the passenger seats are distributed and the spacing between seats. For example, in air travel there are various seating configurations in business class and economy class, wherein parameters such as passenger legroom are influenced by means of the seating configuration.

Generous spacing between seats results in low passenger density, which in turn results in a low heat load in the corresponding region, for example in business class. Conversely, in economy class, small spacing between seats results in higher passenger density and in a higher heat load.

In order to, in the case of different passenger densities, achieve the same temperature in the entire passenger compartment, a region with a low heat load needs to be supplied at a higher air outlet temperature by way of the air outlets, and a region with a high heat load is correspondingly supplied with a lower air outlet temperature by way of the air outlets.

As long as a temperature zone comprises a uniform seating configuration and thus a uniform passenger density, the temperature of each temperature zone can be suitably regulated by way of an identical air outlet temperature of the air outlets in the corresponding temperature zone. However, if a temperature zone does not have a uniform heat load, i.e. the temperature zone comprises several temperature regions with different local heat loads, a uniform temperature can only be achieved by way of different air outlet temperatures in the air outlets of the various temperature regions.

The air distribution system as described above and below makes it possible to set the air outlet temperature of the air outlets in various temperature regions of a temperature zone in that reaction to the local heat load within a temperature region takes place, in that the heating energy relating to the heating elements in the air outlets is set in such a manner that in the entire temperature zone as uniform a temperature as possible is achieved.

A temperature is as uniform as possible if a human passenger cannot perceive a significant temperature difference within a temperature zone by means of the body's own sensor system. A temperature difference will be significant in those cases where the difference exceeds, for example, about 1° to about 2° Kelvin.

The local heat load in a temperature region can, for example, result from the seating configuration and/or the actually occupied seats in the passenger compartment. The actually occupied passenger seats could, for example, be determined in that each seat comprises a sensor that emits a signal to the control unit when the seat is occupied.

From the seating configuration and/or the number of actually occupied seats the control unit can, for example, determine a heat load in a temperature region. The air distribution system as described above and below makes it possible to set the heating energy at the heating elements of the air outlets after determination of the heat load in a first temperature region and after determination of the temperature and of the heat load in a second temperature region of a temperature zone.

However, adjustment of the air outlet temperature can, for example, also take place by means of an individual heating element in the shared air supply or generally by correspondingly heated air from the air supply of all the air outlets. In one example, in this case the air outlets are arranged within an individual temperature region. In this case the air outlet temperature of the heating element in the air supply could be specified such that for example in the second temperature region no heating elements are required in the air outlets in order to bring about the desired temperature in the corresponding temperature zone. Heating elements are then only arranged in the air outlets of the first temperature region because, for example, in the first temperature region the respective local heat load is lower than in the second temperature region, and thus additional heating energy in the air outlets is necessary in order to achieve the same temperature in the first temperature region as in the second temperature region.

For example, a temperature zone that comprises business class and economy class seating configurations could comprise heating elements only in the region of business class, because the seating configuration in business class results in a lower heat load than in economy class, and thus greater heating energy could be required in order to achieve the same temperature in the two seating classes.

In an embodiment the heating energy for the seats or seat rows of business class, which are situated in a temperature zone together with seats or seat rows of economy class, can be determined in that the second air outlet temperature in a second temperature zone, which second temperature zone only comprises business class seats, is used, and the difference in the air outlet temperature from the first air outlet temperature in a first temperature zone, which first temperature zone regulates the air outlet temperature for economy class, is determined. From the thus determined difference in the air outlet temperature it is then possible to determine a required heating energy for the heating elements in the business class region in the second temperature zone, because it is known that the heat load in the second temperature zone, i.e. in business class, is the same as in the first temperature region of the second temperature zone, i.e. in the seat rows of business class, Which seat rows are situated in the second temperature zone.

According to one embodiment of the present disclosure, the passenger compartment comprises at least one temperature sensor, wherein each one of the at least one temperature zones is associated with precisely one temperature sensor designed to measure the temperature in the temperature zone associated with it, and to transmit the result to the control unit. This temperature sensor is a temperature sensor for acquiring an ambient temperature.

Apart from this, each temperature zone can also comprise a temperature sensor for acquiring the air outlet temperature, because the air outlet temperature can be necessary for determining the necessary heating energy in temperature zones comprising several temperature regions.

In this manner the air distribution system may make it possible for a temperature zone to comprise a single temperature sensor and a single control loop for the temperature, while nevertheless, by way of a knowledge of the heat load or of the distribution of the heat load within a temperature zone, allowing various air outlet temperatures at the air outlets of the individual temperature regions to be set in such a manner that the temperature within the entire temperature zone is as uniform as possible.

In this arrangement the air outlets within the first temperature region form part of the first group, and the air outlets within the second temperature region form part of the second group of air outlets, wherein the first group and the second group of air outlets comprise different air outlet temperatures.

According to one embodiment of the present disclosure, the control unit furthermore calculates the heating energy of the healing elements depending on the temperature measured by the temperature sensor.

As already explained, a temperature zone comprises only one temperature sensor for acquiring the ambient temperature, which temperature sensor can naturally be situated only in one temperature region. Thus the actually predominant temperature in a second temperature region cannot be measured. Instead, the control unit is designed, by way of the temperature in the first temperature region and the heat load in the first temperature region as well as the heat load in the second temperature region, to calculate the required heating energy for the heating elements in the second temperature region in such a manner that in the second temperature region a desired temperature is achieved.

According to one embodiment of the present disclosure, the temperature sensor associated with the at least one temperature zone is arranged in or associated with that temperature region that comprises a higher heat load than another temperature region within the same temperature zone. This can, for example, be the second temperature region, which has a higher heat load than the first temperature region of the temperature zone in which the first temperature region and the second temperature region are situated.

Arranging the temperature sensor in the temperature region with a higher heat load may make it possible for, and support, a predetermined temperature in this temperature region not being exceeded. For example in air travel exceeding defined temperature limits may result in passengers experiencing discomfort. Maintaining such a predetermined maximum temperature can be facilitated in that the measuring signal of the temperature is precisely emitted in that temperature region which due to the higher heat load is more likely to be inclined to assume too high a temperature.

According to one embodiment of the present disclosure, the passenger compartment comprises a first temperature zone and a second temperature zone, each comprising a multitude of air outlets, wherein the first temperature region of the first temperature zone adjoins the second temperature zone, and wherein the first heat load in the first temperature region of the first temperature zone corresponds to the heat load in the second temperature zone and is lower than the second heat load of the second temperature region of the first temperature zone, and the heating energy in the first temperature region of the first temperature zone results from a heat load differential between the second heat load of the second temperature region of the first temperature zone and the heat load of the second temperature zone.

The first temperature zone and the second temperature zone can thus, in one example, be temperature zones that are arranged side-by-side or adjacent to each other within the passenger cabin, wherein in one of these temperature zones a varying heat load can arise in that, for example, the seating configuration of the second temperature zone is extended to seat rows of the first temperature zone. In this document the notion of the first temperature zone being adjacent to the second temperature zone means that, for example, in two passenger seat rows, situated one behind another, within the passenger compartment, the air outlets associated with the respective passenger seat rows are in each case associated with a temperature zone, i.e. for example the first and the second temperature zones. Thus one of the passenger rows that are situated directly one behind another is supplied by air outlets of the first temperature zone, while the other passenger seat row is supplied by air outlets of the second temperature zone.

According to one embodiment of the present disclosure, the heat load of a temperature region is predetermined by, or derived from, a passenger density in the corresponding temperature region, wherein an increased passenger density corresponds to an increased heat load of the temperature region.

According to one embodiment of the present disclosure, the heat load of a temperature region is predetermined by, or derived from, a passenger seat distribution in a temperature region, wherein an increased passenger seat density corresponds to an increased heat load of the temperature region.

In contrast to the passenger density, which indicates the seats that are actually occupied by persons, the passenger seat distribution does not indicate whether the seats are actually taken up by persons. Thus even in the case of identical passenger seat density, passenger density can nevertheless result in a different heat load being determined, because it is quite possible that not every seat is taken up by a passenger.

According to one of various aspects of the present disclosure, a means of transport with a passenger compartment as described above and below is stated.

The means of transport can be any means of transport that carries passengers, in which means of transport the passenger compartment temperature is regulated and is to be as uniform as possible. The means of transport can thus be a bus, a train, a ship or boat, or an aircraft.

In that each temperature zone comprises only one temperature sensor and only one control loop for regulating the temperature, it is possible, in particular, to save weight, installation expenditure and costs of temperature regulation.

According to one embodiment of the present disclosure, the means of transport is an aircraft.

According to one of various aspects of the present disclosure, a method for regulating an air outlet temperature of an air distribution system in a passenger compartment of a means of transport, as described above and below, is stated, wherein the air distribution system comprises a control unit, wherein the passenger compartment comprises at least one temperature zone, which at least one temperature zone comprises a multitude of air outlets, which multitude of air outlets share a common air supply, wherein the first temperature region is designed to receive a first heat load, and the second temperature region is designed to receive a second heat load, which first heat load differs from the second heat load, wherein the air distribution system comprises at least one heating element, wherein the at least one heating element is associated with an air outlet and is designed to heat the air flowing from the air outlet, which one air outlet is arranged in that temperature region of the first temperature region and of the second temperature region which comprises a lower heat load, wherein the control unit is designed to determine a temperature in each temperature zone and to calculate a heating energy for the at least one heating element, wherein a first group of the air outlets in the first temperature region is designed to output air of a first air outlet temperature to the passenger compartment, and wherein a second group of the air outlets in the second temperature region is designed to output air of a second air outlet temperature to the passenger compartment, wherein the method comprises the following: calculating the heating energy for the at least one heating element in the air outlet, wherein the at least one heating element is designed to influence the air outlet temperature at the air outlet, wherein calculating the heating energy takes place in such a manner that the temperature in the temperature zone is as uniform as possible.

Thus, the method as described above and below ensures that despite different heat loads the temperature within a temperature zone in several temperature regions is kept constant in that the air outlet temperature of the air outlets in the temperature regions is adjusted in that the heating energy of the heating elements is calculated correspondingly.

According to one embodiment of the present disclosure, the method further comprises the following: determining a first air outlet temperature in a first temperature zone of the at least one temperature zone; determining a second air outlet temperature in a second temperature zone of the at least one temperature zone; calculating the heating energy of the at least one heating element in the first temperature region of the first temperature zone by means of the first air outlet temperature and of the second air outlet temperature; and outputting the heating energy to the at least one heating element.

In one example, the temperature in the first temperature zone in an individual temperature region can be determined by at least two temperature regions of the first temperature zone. Subsequently the heating energy for adjusting the air outlet temperature in a further temperature region of the first temperature zone can be determined in that the difference in the air outlet temperature with regard to a second temperature zone is determined, and from this difference in the air outlet temperature the required heating energy for the heating elements of the temperature region with the lower heat load within the first temperature zone is determined.

According to one embodiment of the present disclosure, the first air outlet temperature is determined in the second temperature region of the first temperature zone.

In this arrangement the second temperature region of the first temperature zone can comprise a higher heat load than the first temperature region of the first temperature zone, and consequently, in the first temperature region, in order to increase the air outlet temperature therein, the heating energy is correspondingly increased in order to achieve a uniform temperature in the first temperature zone.

According to one embodiment of the present disclosure, calculation of the heating energy takes place with the use of the difference between the first air outlet temperature and the second air outlet temperature.

In other words this means that the first temperature zone comprises, for example, economy class seating configuration in the second temperature region, and business class seating configuration in the first temperature region, which due to different passenger densities in these temperature regions results in different heat loads. If the ambient temperature in the second temperature region is then measured and adjusted by means of the control loop in order to achieve a predetermined ambient temperature, the air outlet temperature in the first temperature region can be too low in order to, based on the low heat load in that region, achieve the same ambient temperature. Thus, in the first temperature region additional heating energy for the heating elements is then required, and consequently the air outlet temperature in the first temperature region is higher than in the second temperature region.

The additional heating energy is determined in that the air outlet temperature of a second temperature zone is used, which second temperature zone comprises business class seating configuration. Since this region requires a higher air outlet temperature, when compared to economy class, for the same ambient temperature to be achieved, the difference in the air outlet temperature between business class and economy class can be determined as the difference between the respective air outlet temperatures, and from this difference in turn the additional heating energy necessary for increasing the air outlet temperature in the first temperature region, i.e. in the business class region, of the first temperature zone can be determined.

According to one embodiment of the present disclosure, the method furthermore comprises: determining the temperature in each temperature zone of the at least one temperature zone or of the multitude of temperature zones, wherein in each case the temperature in that temperature region of each temperature zone is determined, in which temperature region the highest heat load is present, in particular the highest heat load within said temperature zone.

According to one of various aspects of the present disclosure, a computer program element for controlling an air distribution system as described above and below is stated, which computer program element is designed to implement the method as described above and below when said computer program element is executed on a processor of a control unit of the air distribution system.

According to one of various aspects of the present disclosure, a computer-readable medium comprising a computer program element as described above and below is stated.

The computer-readable medium can, for example, be a hard disc, a removable or permanent memory module, a diskette, a CD-ROM, a DVD and any other writable or merely readable medium that is suitable for containing a computer program element, and to make it available to a processor of an arithmetic unit for readout.

In other words it can also be said that the present disclosure relates to an aircraft cabin with at least one temperature zone, wherein for the purpose of air conditioning the aircraft cabin the temperature zone comprises a multitude of air outlets that share a common air supply, characterized in that a first one of the at least one temperature zones comprises a first temperature region and a second temperature region, wherein the second temperature region is designed to receive a higher heat load than the first temperature region, and in that the outlet air of at least one of the air outlets in the first temperature region can be heated in a controlled manner with controlled heating energy in such a manner that by means of the outlet air heated in a controlled manner different heat loads in the first and in the second temperature regions can be balanced out.

In one example, in this arrangement the aircraft cabin comprises at least two temperature zones, wherein each temperature zone for air conditioning the aircraft cabin in each case comprises a multitude of air outlets, wherein the multitude of air outlets of a temperature zone share a common air supply, and wherein a second one of the at least two temperature zones adjoins the first temperature region of the first temperature zone, characterized in that the outlet air of the at least one of the air outlets in the first temperature region of the first temperature zone can be heated by means of controlled heating energy, wherein the controlled heating energy is based on the difference between a first temperature, measured in the second temperature region of the first temperature zone, and a second temperature, measured in the second temperature zone.

Below, exemplary embodiments of the present disclosure are described with reference to the drawings. A person skilled in the art can gather other characteristics and advantages of the disclosure from the following description of exemplary embodiments that refers to the attached drawings, wherein the described exemplary embodiments should not be interpreted in a restrictive sense.

### BRIEF DESCRIPTION OF THE DRAWINGS

The various embodiments will hereinafter be described in conjunction with the following drawing figures, wherein like numerals denote like elements, and wherein:

FIG. 1 shows a passenger compartment with an air distribution system for a means of transport according to one exemplary embodiment of the present disclosure.

FIG. 2 shows a temperature zone of a passenger compartment according to one exemplary embodiment of the present disclosure.

FIG. 2A shows a temperature zone of a passenger compartment according to one exemplary embodiment of the present disclosure.

FIG. 3 shows a passenger compartment with a multitude of temperature zones and temperature regions according to one exemplary embodiment of the present disclosure.

FIG. 4 shows an aircraft comprising a passenger compartment with an air distribution system according to one exemplary embodiment of the present disclosure.

FIG. 5 shows a method for regulating an air outlet temperature of an air distribution system for a passenger compartment according to one exemplary embodiment of the present disclosure.

FIG. 6 shows a computer-readable medium according to one exemplary embodiment of the present disclosure.

### DETAILED DESCRIPTION

The following detailed description is merely exemplary in nature and is not intended to limit the present disclosure or the application and uses of the present disclosure. Furthermore, there is no intention to be bound by any theory presented in the preceding background or the following detailed description.

The illustrations in the figures are diagrammatic and not to scale. If in the following description of the figures the same reference characters are used, they relate to identical or similar elements.

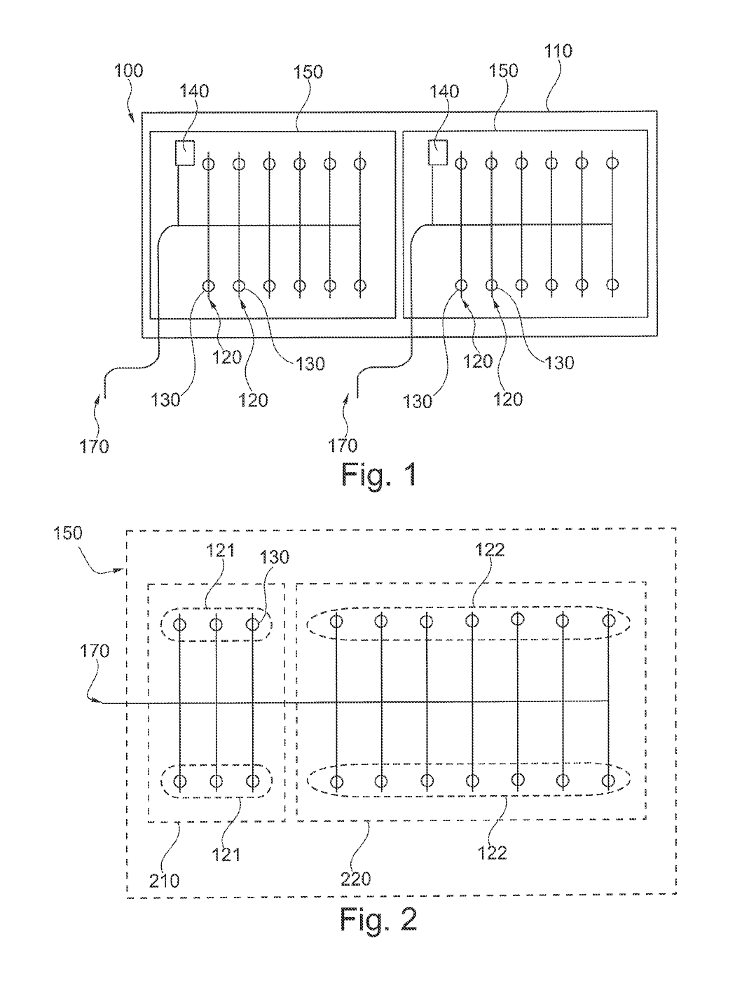

FIG. 1 shows a passenger compartment 110 with an air distribution system 100 or an air distribution system 100 for a passenger compartment 110 according to one exemplary embodiment of the present disclosure. The passenger compartment 110 is divided into two temperature zones 150, wherein each temperature zone comprises a multitude of air outlets 120 that are connected to a shared air supply 170 or are supplied with air by means of this air supply.

In order to bring the temperature in a temperature zone 150 to a desired value or keep it at this value or stabilize it, the air distribution system 100 comprises a control unit 140 that is designed to control heating elements 130 in the air outlets 120 in such a manner that the heating elements, by way of a variable supply of heating energy, heat the air that flows from the air outlet into the passenger compartment.

In order to determine the heating energy for the heating elements, in each temperature zone a temperature sensor (for the sake of clarity not shown in the drawing) is arranged which transmits the measured temperature to the control unit.

Although FIG. 1 shows a control unit in each temperature zone, it is likewise possible for a single control unit to monitor several temperature zones and to regulate their temperatures or the supply of heating energy to the heating elements.

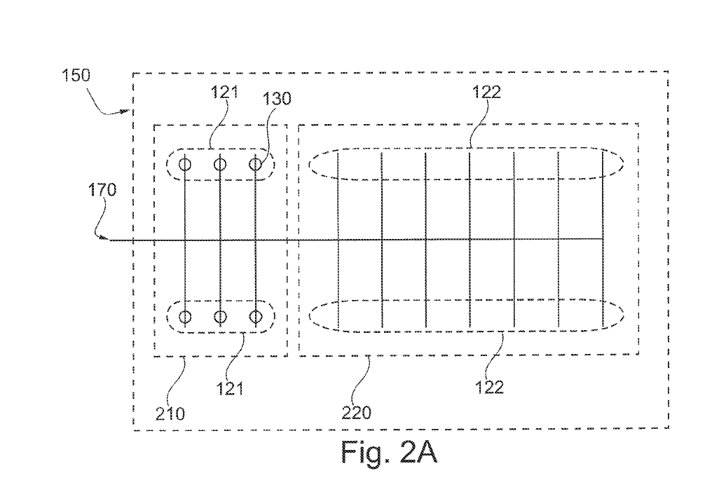

FIG. 2 shows a temperature zone 150 with a first temperature region 210 and a second temperature region 220. The air outlets 120 are supplied with air by way of the shared air supply 170, wherein during flowing from the air outlets 120 into the passenger compartment the air is heated by a heating element 130.

If the first temperature region 210 comprises a heat load that differs from the heat load in the second temperature region 220, the heating elements of the air outlets of the first group 121 need to be supplied with heating energy that differs from that of the heating elements of the air outlets of the second group 122.

The different heating energy for the healing elements of the first group 121 and of the second group 122 is determined in that in a single one of the temperature regions 210, 220 the temperature is measured by means of a temperature sensor, and the heat load in the first temperature region 210 and in the second temperature region 220 is determined.

In this manner a difference in the heating load between the first temperature region 210 and the second temperature region 220 can be determined and by way of the known temperature in one of the temperature regions the required heating energy for the heating elements in the other temperature region can be determined in order to obtain a uniform temperature in the entire temperature zone 150 despite different heat loads in the temperature regions 210, 220.

The required heating output for balancing the various heat loads in the temperature regions results from the mass flow of the air flowing from the air outlet, and from the difference in the heat load or from the temperature difference in the unheated state between the temperature regions.

The mass flow of the air, in turn, results from the density of the air and the latter's volume flow, wherein the density in turn results from the air pressure in the passenger compartment and from the air temperature in the air supply.

FIG. 2A shows a temperature zone 150 with a first temperature region 210 and a second temperature region 220, wherein in each case only the air outlets in the first temperature region 210 comprise a heating element 130. In case the heat load in the first temperature region 210 is lower than in the second temperature region 220, heating elements 130 are provided in the air outlets of the first group 121 of air outlets so that during the supply of the heating elements with heating energy the air flowing out in the first temperature region 210 is warmer than the air flowing from the air outlets of the second group 122.

In this arrangement the heating energy, which may be required, for the heating elements is calculated as described in detail further above.

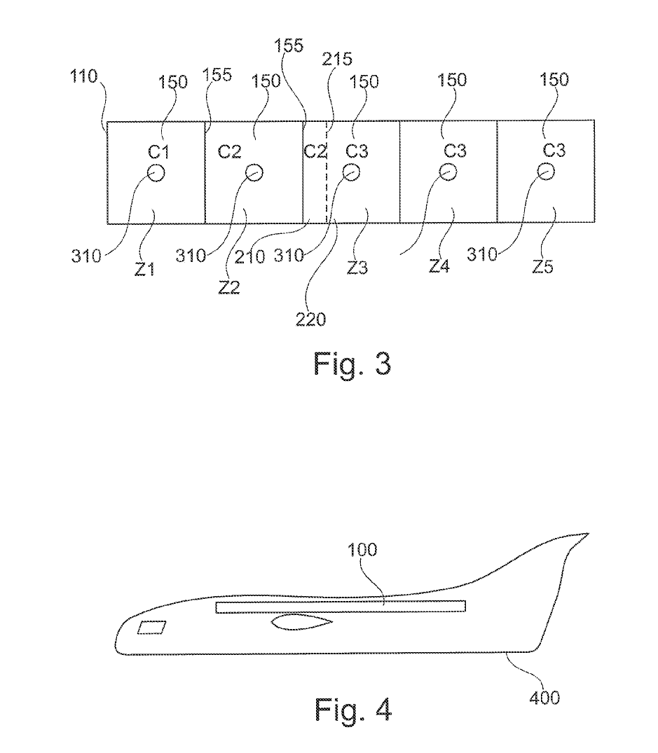

FIG. 3 shows a passenger compartment 110 with five temperature zones 150 Z1 to Z5. In each case between two temperature zones 150 there is a temperature zone boundary 155, and each temperature zone has a temperature sensor 310.

In the passenger compartment 110 there are three different seating configurations C1, C2 and C3. The seating configuration C1 can, for example, correspond to first class in a passenger cabin of an aircraft; C2 can correspond to the seating configuration in business class; and C3 to the seating configuration in economy class.

The different seating configurations in each case comprise individual seat spacing, wherein in the region of each seating configuration there is a different passenger density. The different passenger density results in different heat loads, i.e. for example a different quantity of heat emitted to the environment as a result of passengers' body warmth. Depending on the heat load, in the region of different seating configurations differently heated air needs to flow from the air outlets into the passenger compartment in order to achieve the same temperature in the region of different seating configurations.

Now if a change in the seating configuration occurs precisely at a temperature zone boundary 155, this does not pose a problem for temperature regulation. This situation is shown in zones Z1 and Z2 with the seating configurations C1 and C2. Temperature zone Z1, just like Z2, has a temperature sensor of its own which acquires the cabin temperature current at that time in the respective temperature zone and transmits it to the control unit so that the control unit can, if necessary, increase the heating energy or the air outlet temperature in too cold a temperature zone, or can cause the aforesaid to be increased.

However, if a change in the seating configurations within a temperature zone takes place, this can result in different temperatures in the region of the different seating configurations, namely depending on the placement of the temperature sensor. This situation is shown in temperature zone Z3 in which the seating configurations C2 and C3 exist. This results in the temperature zone Z3 comprising a first temperature region 210 and a second temperature region 220, wherein a temperature region boundary 215 passes precisely between the seating configurations C2 and C3, because this is where the passenger density changes.

If the temperature sensor is located in a temperature region with a high heat load, and if the temperature in this region corresponds to the setpoint value of the temperature, no heating takes place, which, however, in a temperature region with a low heat load in the same zone can result in the temperature being too low therein. Conversely, an arrangement of the temperature sensor in the temperature region with a low heat load can result in the temperature region with a high heat load being heated too much.

If the heat load in one temperature zone differs from the heat load in some other temperature zone, uniform temperature in the entire passenger cabin can be achieved in that in the temperature zone with a lower heat load air that has been heated more flows from the air outlets, i.e. that the heating elements in the temperature zone with a lower heat load are operated with more healing energy or the air outlet temperature is higher. In this manner a situation is achieved in which despite a lower heat load the same temperature prevails as is the case in a temperature zone with a higher heat load.

Thus the situation in the temperature zone Z3 is as shown in the temperature zone 150 in FIG. 2. In the region of the seating configuration C2 there is a first temperature region 210, and in the region of the seating configuration C3 there is a second temperature region 220.

Corresponding to the heat load in the temperature regions 210, 220 or in the region of the seating configurations C2, C3, within the same temperature zone Z3 the air flowing from the air outlets of the first group 210 and of the second group 220 needs to be heated differently in order to attain the same temperature within the temperature zone Z3. However, since only one temperature sensor 310 is arranged in the temperature zone Z3 and in the temperature region 220, a differing required heating energy in one temperature region 210 can thus be determined by way of the differing or different heat load between the temperature regions 210, 220 in that the required additional heating energy for business class in the temperature zone Z3 is determined from a difference in the air outlet temperature between temperature zones Z3 (business class with economy class mixed, wherein the temperature sensor is arranged in the region of economy class, and the air outlet temperature is thus guided by the heating requirements of this class) and Z2.

As already explained, the difference in the heat load can be a predetermined value that is set at the control unit, or the difference in the heat load or the heat load in the two temperature regions is determined with reference to passenger density and/or the seating configuration and/or constructional specifications such as, for example, cabin insulation. In the determination of the additionally required heating energy from the difference in the air outlet temperature between two temperature zones, the difference in the heat load between two temperature zones is indirectly determined by way of the different actual air outlet temperature at the time. There is thus no need to explicitly determine the heat load.

FIG. 4 shows an aircraft 400 with a passenger compartment 110 with an air distribution system 100 according to one exemplary embodiment of the present disclosure.

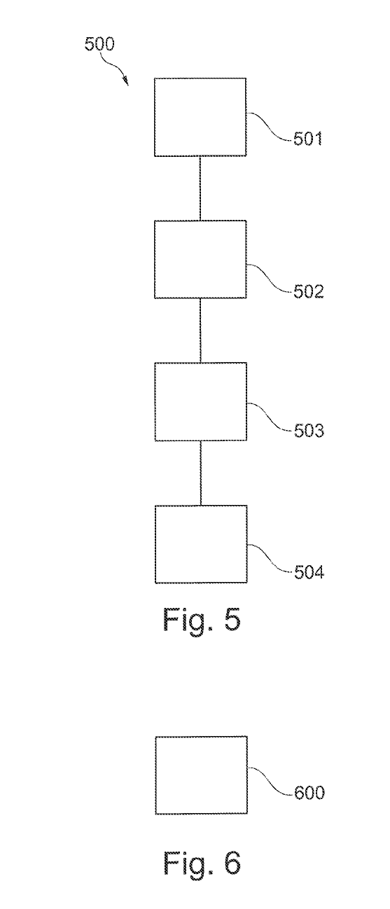

FIG. 5 shows a diagrammatic overview of a method 500 for regulating an air outlet temperature of an air distribution system in a passenger compartment according to one exemplary embodiment of the present disclosure.

At 501, a heating energy for the heating element in the air outlet is calculated as described above. Thereafter, at 502, in a first temperature zone in the passenger compartment a first air outlet temperature is determined. At 503, a second air outlet temperature in a second temperature zone is determined. At 504, a heating energy for the heating elements in the first temperature region of the first temperature zone is calculated as described above, with reference to the first air outlet temperature and the second air outlet temperature. The additional heating energy calculated in this manner is then output to the heating element, or the heating element is operated with the calculated heating energy, in order to correspondingly heat the air flowing from the air outlet.

Thus, the method 500 may make it possible, in a passenger compartment with a multitude of temperature zones, of which each temperature zone can comprise several temperature regions, to regulate a temperature in such a manner that the temperature in the entire temperature zone is as uniform as possible, wherein in a temperature zone only one temperature sensor is arranged.

FIG. 6 shows a diagrammatic view of a computer-readable medium with a computer program element for implementing a method, described above, on a control unit of a passenger compartment, described above, with an air distribution system.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the present disclosure in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the present disclosure as set forth in the appended claims and their legal equivalents.

1. A passenger compartment with an air distribution system for a means of transport, with the air distribution system comprising:
a control unit;
a plurality of air outlets; and
at least one heating element;
wherein the passenger compartment comprises at least one temperature zone with a first temperature region and a second temperature region;
wherein the first temperature region is designed to receive a first heat load, and the second temperature region is designed to receive a second heat load, which first heat toad differs from the second heat load;
wherein the at least one temperature zone comprises the plurality of air outlets, which plurality of air outlets share a common air supply;
wherein the at least one heating element is associated with one of the plurality of air outlets in order to heat the air flowing from the one air outlet, which one air outlet is arranged in one of the first temperature region and the second temperature region that comprises a lower heat load than the other temperature region;
wherein the control unit is designed to determine a temperature in the at least one temperature zone, and to determine a heating energy for the at least one heating element;
wherein a first group of the plurality of air outlets in the first temperature region is designed to output air of a first air outlet temperature to the passenger compartment;
wherein a second group of the plurality of air outlets in the second temperature region is designed to output air of a second air outlet temperature to the passenger compartment; and
wherein the control unit is designed to calculate the heating energy for the at least one heating element in such a manner that in the at least one temperature zone an essentially uniform temperature is achieved.

2. The passenger compartment of claim 1,
further comprising a plurality of temperature sensors and the at least one temperature zone comprises a plurality of temperature zones;
wherein each one of the plurality of temperature zones is associated with one of the plurality of temperature sensors, each of the plurality of temperature sensors designed to measure the temperature in the respective one of the plurality of temperature zones, and to transmit the result to the control unit.

3. The passenger compartment of claim 2,
wherein the one of the plurality of temperature sensors that is associated with the one of the plurality of temperature zones is arranged in the second temperature region of the one of the plurality of temperature zones;
wherein the second temperature region has a higher heat load than the first temperature region of the one of the plurality of temperature zones.

4. The passenger compartment of claim 1,
wherein the at least one temperature zone comprises a first temperature zone and a second temperature zone and each of the first temperature zone and the second temperature zone comprise a plurality of air outlets;
wherein the first temperature region of the first temperature zone adjoins the second temperature zone; and
wherein the first heat load in the first temperature region of the first temperature zone corresponds to the heat load in the second temperature zone and is lower than the second heat load of the second temperature region of the first temperature zone, and the heating energy in the first temperature region of the first temperature zone results from a difference in heat load between the second heat load of the second temperature region of the first temperature zone and the heat load of the second temperature zone.

5. The passenger compartment of claim 4,
wherein the control unit is designed to determine the difference in heat load as the difference between the second air outlet temperature in the second temperature region of the first temperature zone and an air outlet temperature in the second temperature zone.

6. A means of transport with a passenger compartment, the means of transport comprising:
the passenger compartment including at least one temperature zone with a first temperature region and a second temperature region, the first temperature region receives a first heat load and the second temperature region receives a second heat load, and the first heat load is different from the second heat load,
an distribution system in the passenger cabin, the air distribution system comprising:
a control unit;
a plurality of air outlets that share a common air supply, and the at least one temperature zone includes the plurality of air outlets, a first group of the plurality of air outlets in the first temperature region outputs air of a first air outlet temperature to the passenger compartment and a second group of the plurality of air outlets in the second temperature region outputs air of a second air outlet temperature to the passenger compartment; and
at least one heating element associated with one of the plurality of air outlets in order to heat the air flowing from the one air outlet, which one air outlet is arranged in the temperature region of the first temperature region and of the second temperature region, which temperature region comprises a lower heat load than the other temperature region;
wherein the control unit is designed to determine a temperature in the at least one temperature zone, to determine a heating energy for the at least one heating element and to calculate the heating energy fir the at least one heating element in such a manner that in the at least one temperature zone an essentially uniform temperature is achieved.

7. The means of transport of claim 6,
wherein the means of transport is an aircraft.

8. A method for regulating an air outlet temperature of an air distribution system in a passenger compartment of a means of transport, with the air distribution system comprising a control unit, the passenger compartment comprising at least one temperature zone with a first temperature region and a second temperature region the at least one temperature zone including a plurality of air outlets that share a common air supply, the first temperature region is designed to receive a first heat load, and the second temperature region is designed to receive a second heat load, which first heat load differs from the second heat load, the air distribution system comprises at least one heating element, associated with one air outlet of the plurality of air outlets and is designed to heat the air flowing from the one air outlet, which one air outlet is arranged in one of the first temperature region and the second temperature region that comprises a lower heat load, and the control unit is designed to determine a temperature in each temperature zone and to calculate a heating energy for the at least one heating element, with a first group of the plurality of air outlets in the first temperature region designed to output air of a first air outlet temperature to the passenger compartment, and a second group of the plurality of air outlets in the second temperature region designed to output air of a second air outlet temperature to the passenger compartment, the method comprising the steps of:
calculating the heating energy for the at least one heating element in the one air outlet, the at least one heating element influencing the air outlet temperature at the plurality of air outlets,
wherein calculating the heating energy takes place in such a manner that in the at least one temperature zone a temperature is achieved that is essentially uniform.

9. The method of claim 8, further comprising the steps of:
determining a first air outlet temperature in a first temperature zone of the at least one temperature zone;
determining a second air outlet temperature in a second temperature zone of the at least one temperature zone;
calculating the heating energy of the at least one heating element in the first temperature region of the first temperature zone by the first air outlet temperature and the second air outlet temperature; and
outputting the heating energy to the at least one heating element.

10. The method of claim 9,
wherein the first air outlet temperature is determined in the second temperature region of the first temperature zone.

11. The method of claim 9,
wherein calculating the heating energy is based on the difference between the first air outlet temperature and the second air outlet temperature.

12. The method of claim 8, wherein the at least one temperature zone comprises a plurality of temperature zones and the method further comprises the step of:
determining a temperature in each temperature zone of the plurality of temperature zones;
wherein in each case the temperature in each temperature zone of the plurality of temperature zones is determined based on the highest heat load.

13.-14. (canceled)

15. A computer program product for controlling an air distribution system of a passenger compartment of a means of transport, comprising:
a computer-readable medium including the computer program product readable by a processor of a control unit of the air distribution system to direct the air distribution system to carry out a method comprising the steps of:
calculating a heating energy for at least one heating element in an air outlet, the at least one heating element influencing the air outlet temperature at a plurality of air outlets, the passenger compartment including at least one temperature zone with a first temperature region and a second temperature region, the at least one temperature zone comprises the plurality of air outlets that share a common air supply, the first temperature region is designed to receive a first heat load, and the second temperature region is designed to receive a second heat load, which first heat load differs from the second heat load,
wherein calculating the heating energy takes place in such a manner that in the at least one temperature zone a temperature is achieved that is essentially uniform.

16. The computer program product of claim 15, wherein the method further comprises the steps of:
determining a first air outlet temperature in a first temperature zone of the at least one temperature zone;
determining a second air outlet temperature in a second tempera re zone of the at least one temperature zone;
calculating the heating energy of the at least one heating element in the first temperature region of the first temperature zone by the first air outlet temperature and the second air outlet temperature; and
outputting the heating energy to the at least one heating element.

17. The computer program product of claim 16, wherein the method further comprises the steps of:
wherein the first air outlet temperature is determined in the second temperature region of the first temperature zone.

18. The computer program product of claim 16, wherein the method further comprises the steps of:
wherein calculating the heating energy is based on the difference between the first air outlet temperature and the second air outlet temperature.

19. The computer program product of claim 15, wherein at least one temperature zone comprises a plurality of temperature zones and the method further comprises the steps of:
determining a temperature in each temperature zone of the plurality of temperature zones;
wherein in each case the temperature in each of the plurality of temperature zones is determined based on the highest heat load.
